(19) United States
(12) Patent Application Publication
(10) Pub. No.: US 2012/0255496 A1
(43) Pub. Date: Oct. 11, 2012

(54) Lil' Orphan Animal Nurser

(76) Inventors: Kathryn M. Federico, Poughkeepsie, NY (US); Sharon O. Vigne, Ossining, NY (US)

(21) Appl. No.: 13/083,209

(22) Filed: Apr. 8, 2011

(51) Int. Cl. A01K 7/00

(52) U.S. Cl. 119/72

(57) ABSTRACT

An animal feeder to feed animal may include a hollow housing being substantially kidney shaped and the hollow housing may having a concave section being defined by a first concave surface and a pair of opposed convex surfaces. The animal feeder may include a feeding device to feed the animals, and the animal feeds from the feeding device within the concave section.

### FIELD OF THE INVENTION

The present invention relates to feeders and more particularly to a pet and animal feeder.

### BACKGROUND

A great many people are involved with caring for animals across our country and the world. It is just a matter of human compassion to help care for animals that are unable to care for themselves and would die without outside assistance. Perhaps the most common animals that require help are orphaned or abandoned kittens, puppies and the like. Whether as a result of their mother dying during birth, or simply discarded because they are not wanted, these animals tug the hardest at our hearts. One of the biggest problems with such animals is getting them to feed or nurse. Any attempt by a human to feed such animals with a bottle is usually met with resistance due to the fact that the animal is not familiar with the bottle and is not comfortable.

U.S. Pat. No. 4,309,008 discloses a baby feeder having front and rear plate members and a leaf member configured for interconnecting the other two adjacent the midpoint thereof for forming an easel, the front plate member having a pocket in the upper edge thereof configured for receiving a baby bottle. Each of the front and rear plate members and leaf member are provided with apertures aligned and configured for receiving a single strand of an elastic member which is interlaced through the apertures to provide a hingeable connection between the leaf member and the front and rear plate members, the elastic member also forming a harness for retaining a baby bottle in the pocket in a baby feeding position. There is also provided beads at the front and rear of said harness for adjusting tension to accommodate different size lengths and widths of said bottle.

U.S. Pat. No. 5,188,061 discloses a pet and animal feeder which provides small pets and animals with nursing means within a surrounding soft material. The present invention provides a container with a plurality of nippled, hollow protuberances simulating the teats depending from a mother. The container is positioned in a cavity within a stuffed cushion having an external shape similar to the adult version of the mammal for which the invention is being used. The nippled protuberances protrude from the cushion, through apertures in the cushion, and are available for suckling by the newborns

U.S. Pat. No. 6,752,103 discloses a heated animal nurser being provided to assist young animals in nursing and feeding, and can be for use with kittens, puppies, and similar animals.

U.S. Pat. No. 6,592,084 discloses a detachable flexible baby bottle holder controlling displacement of the bottle during feeding. The bottle is held within a cavity by a flexible, soft, elastomeric element, which is secured against the infant's chest using plurality of adjustable straps. Tensile forces exerted by the straps on the elastomeric, soft, flexible bottle holder create an elliptically shaped cavity in which the bottle resides. Movement of the bottle within the elliptically shaped cavity tracks movement of the infant, providing controlled displacement of said bottle in directions corresponding thereto. Bottle motion is accommodated during feeding within a range of several centimeters, minimizing application of transverse and vertical forces otherwise exerted by the nipple. Compliance required for the baby bottle holding system is achieved by the cooperative combination of the elliptical cavity, the flexibility and softness of the trapezoidal element and the tension imposed by the adjustable straps. The compliance and holding are such that bottle tracking is facilitated in each of the lateral and vertical directions, so control between the infant's mouth and the nipple is maintained. Such “tracking action” advantageously enables the bottle to be available for nursing at all times without applying excessive pressure against the infant's mouth. Importantly, the infant can stop nursing at any time, without having to reject the nipple.

### SUMMARY

An animal feeder to feed animal may include a hollow housing being substantially kidney shaped and the hollow housing may having a concave section being defined by a first concave surface and a pair of opposed convex surfaces. The animal feeder may include a feeding device to feed the animals, and the animal feeds from the feeding device within the concave section.

The feeding device may be substantially L-shaped and the feeding device may include a feeding tube.

The feeding device may include a storage container, and the feeding device may include a nipple for the animal to feed from.

The pet and animal feeder may include insulation around the feeding device, and the back surface of the pet feeder may include a fastener device to provide access to the feeding device.

The fastener device may include a zipper, and the feeder device may extend to the top surface of the pet feeder.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the pet and animal feeder of the present invention;

FIG. 2 illustrates a front view of the pet and animal feeder of the present invention;

FIG. 3 illustrates a back view of the pet and animal feeder of the present invention;

FIG. 4 illustrates a side view of the pet and animal feeder of the present invention;

FIG. 5 illustrates another back view of the pet and animal feeder of the present invention;

FIG. 6 illustrates a side view of the feeder device of the present invention;

FIG. 7 illustrates a front view of the feeder device of the present invention;

FIG. 8 illustrates a top view of the feeder device of the present invention;

FIG. 9 illustrates a sectional view of the pet and animal feeder of the present invention;

FIG. 10 illustrates a another front view of the pet and animal feeder of the present invention;

FIG. 11 illustrates another sectional view of the pet and animal feeder of the present invention;

FIG. 12 illustrates a back view of the pet and animal feeder of the present invention.

### DETAILED DESCRIPTION

The present invention provides a pillow like device that may be used for the purpose of feeding animals which may be small and orphaned. The present invention creates a more natural feeding position for feeding baby animals than hand feeding or other prior art devices. In addition, the feeding device of the present invention may be covered with an outer fuzzy material and filled with an inner stuffing to help provide the feel of a mother and the present invention allows the nursing baby to knead. The nursing bottles may be angled and locked into position to prevent excess air intake and the bottles may be surrounded by an insulation that keeps the Formula warm. The bottles may be easily accessed through a zippered outer covering. This animal nurser may be placed in a secure setting with animals, such as a box and can feed multiple animals without the need of hand feeding. This results in a significant timesaver for the owners of the animals.

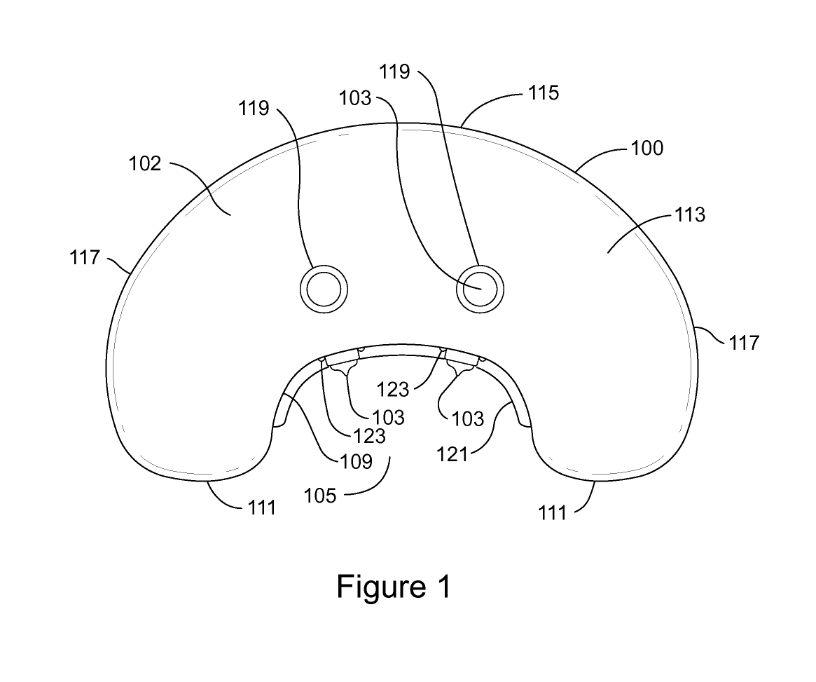

FIG. 1 illustrates a top view of the pet and animal feeder 100 which may include a hollow housing 102 which may include multiple feeder devices 103 or a single feeder device 103 and the pet and animal feeder 100 may be formed from a flexible material. The pet and animal feeder 100 may be hollow and may be filled with foam or other similar particles in order to provide a pillow like device. The construction of the pet and animal feeder 100 tends to sooth and to provide a calming influence on the pet or animal which may feed from the pet and animal feeder 100.

The pet and animal feeder 100 may be substantially kidney shaped and may include a concave section 105 which may include the feeder devices 103 in order to provide a limited or restrictive shelter area from outside influences in order to increase the soothing and calming influence on the pet or animal, and the concave section 105 may be defined by a first front surface 107 which may have a first concave surface 109 and a pair of opposing second concave surfaces 111 which may be connected to the first concave surface 109.

FIG. 1 additionally illustrates a top surface 113 which may be connected to the front surface 107 and which may be kidney shaped and illustrates a back surface 115 which may be opposed to the front surface 107 and which may be convexly curved. The top surface 113 may be connected to a side surface 117 which may be connected to the back surface 115 and which may be convexly curved and which may be connected to the front surface 117. The top surface and may include apertures for a flexible seal 119 which may be an O-ring to releasably hold the feeder device 103. FIG. 1 additionally illustrates an outward extending protrusion 121 to provide a support surface for the pet or animals so that they may knead their pawls while using the feeder device 103. The pet and animal feeder 100 may include a weight for stabilization.

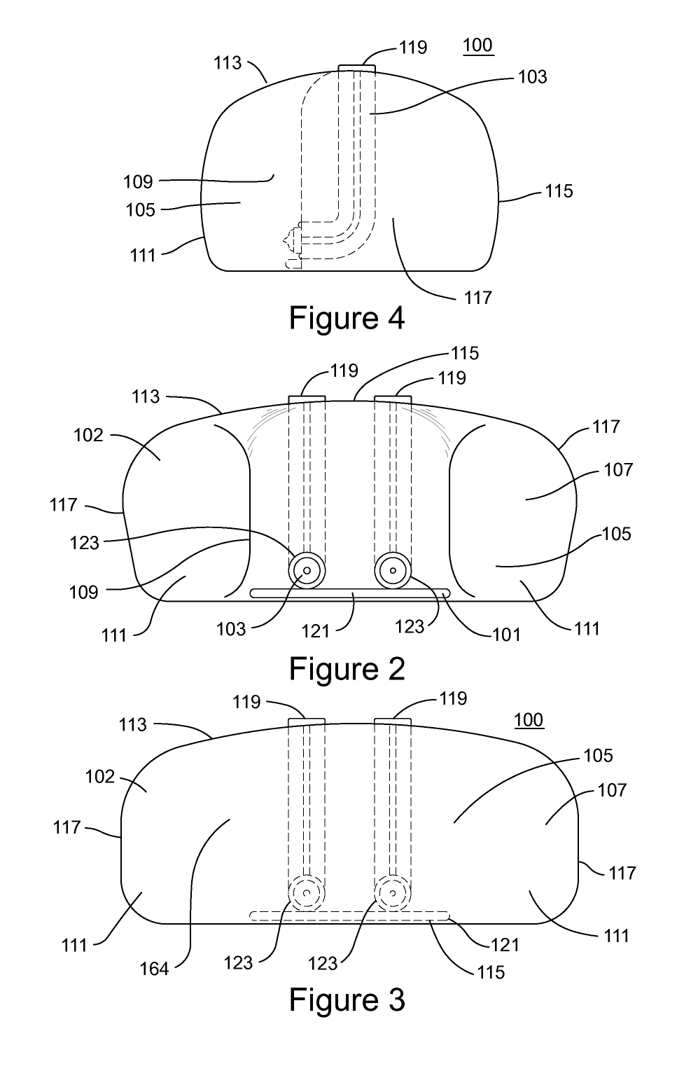

FIG. 2 illustrates that the pet and animal feeder 100 may be substantially kidney shaped and may include a concave section 105 which may include the feeder devices 103 in order to provide a limited or restrictive shelter area from outside influences in order to increase the soothing and calming influence on the pet or animal, and the concave section 105 may be defined by a first front surface 107 which may have a first concave surface 109 and a pair of opposing second concave surfaces 111 which may be connected to the first concave surface 109.

FIG. 2 additionally illustrates a top surface 113 which may be connected to the front surface 107 and which may be kidney shaped and illustrates a back surface 115 which may be opposed to the front surface 107 and which may be convexly curved. The top surface 113 may be connected to a side surface 117 which may be connected to the back surface 115 and which may be convexly curved and which may be connected to the front surface 117. The top surface and may include apertures for a first flexible seal 119 which may be an O-ring to releasably hold the feeder device 103. The front surface and may include apertures for a second flexible seal 123 which may be an O-ring to releasably hold the feeder device 103.

FIG. 2 additionally an outward extending protrusion 121 to provide a support surface for the pet or animals so that they may knead their pawls while using the feeder device 103.

FIG. 3 illustrates that the pet and animal feeder 100 may include a concave section 105 which may include the feeder devices 103 in order to provide a limited or restrictive shelter area from outside influences in order to increase the soothing and calming influence on the pet or animal, and the concave section 105 may be defined by a first front surface 107 which may have a first concave surface 109 and a pair of opposing second concave surfaces 111 which may be connected to the first concave surface 109.

FIG. 3 additionally illustrates a top surface 113 which may be connected to the front surface 107 and which may be kidney shaped and illustrates a back surface 115 which may be opposed to the front surface 107 and which may be convexly curved. The top surface 113 may be connected to a side surface 117 which may be connected to the back surface 115 and which may be convexly curved and which may be connected to the front surface 117. The top surface and may include apertures for a first flexible seal 119 which may be an O-ring to releasably hold the feeder device 103. The front surface and may include apertures for a second flexible seal 123 which may be an O-ring to releasably hold the feeder device 103.

FIG. 3 additionally an outward extending protrusion 121 to provide a support surface for the pet or animals so that they may knead their pawls while using the feeder device 103.

FIG. 4 illustrates a side view of the pet animal feeder 100 and illustrates the feeder device 103, the concave section 105, the first concave surface 109, the second concave surface 111, the back surface 115, the side surface 117, and the flexible seal 119.

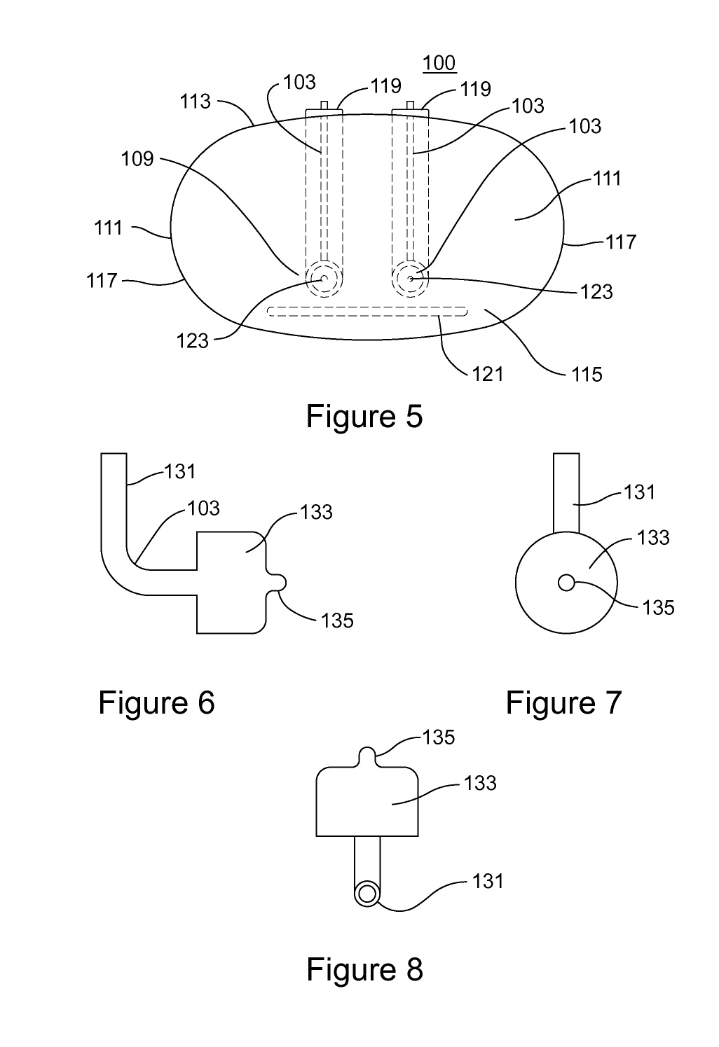

FIG. 5 illustrates that the pet and animal feeder 100 may be substantially kidney shaped and may include a concave section 105 which may include the feeder devices 103 in order to provide a limited or restrictive shelter area from outside influences in order to increase the soothing and calming influence on the pet or animal, and the concave section 105 may be defined by a first front surface 107 which may have a first concave surface 109 and a pair of opposing second concave surfaces 111 which may be connected to the first concave surface 109.

FIG. 5 additionally illustrates a top surface 113 which may be connected to the front surface 107 and which may be kidney shaped and illustrates a back surface 115 which may be opposed to the front surface 107 and which may be convexly curved. The top surface 113 may be connected to a side surface 117 which may be connected to the back surface 115 and which may be convexly curved and which may be connected to the front surface 117. The top surface and may include apertures for a first flexible seal 119 which may be an O-ring to releasably hold the feeder device 103. The front surface and may include apertures for a second flexible seal 123 which may be an O-ring to releasably hold the feeder device 103.

FIG. 5 additionally illustrates an outward extending protrusion 121 to provide a support surface for the pet or animals so that they may knead their pawls while using the feeder device 103.

FIG. 6 illustrates a side view of the feeding device 103 which may be hollow and fillable from the top of the feeding tube 131 which may be L-shaped and connect to the storage container 133 which may be connected to a feeding nipple 135.

FIG. 7 illustrates a front view of the feeding device 103 which may be hollow and fillable from the top of the feeding tube 131 which may be L-shaped and connect to the storage container 133 which may be connected to a feeding nipple 135.

FIG. 8 illustrates a top view of the feeding device 103 which may be hollow and fillable from the top of the feeding tube 131 which may be L-shaped and connect to the storage container 133 which may be connected to a feeding nipple 135.

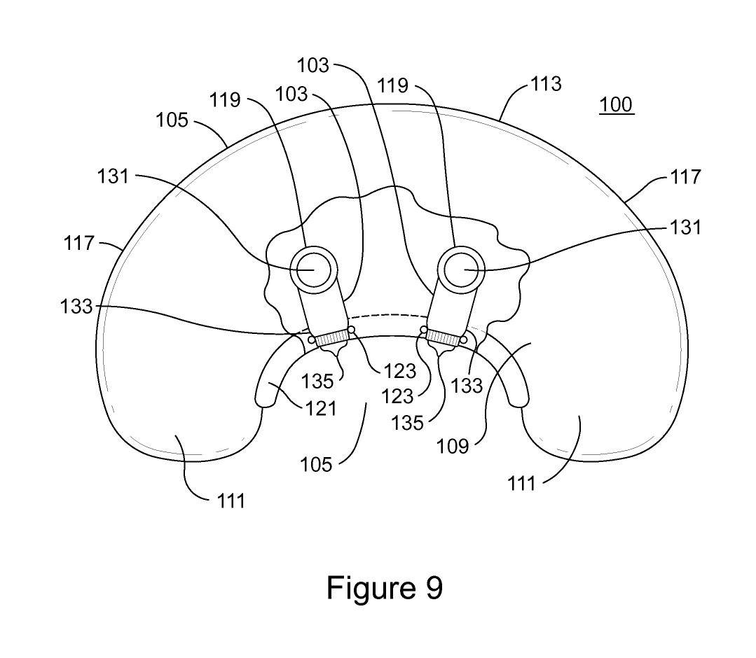

FIG. 9 illustrates a sectional view of the pet and animal feeder 100 and illustrates the feeding device 103, the concave section 105 the first concave surface 109, the second concave surface 111, the top surface 113, the back surface 115, the side surface 117, the first flexible seal 119, the second flexible seal 123, the outward extending protrusion 121 the feeding tube 131, the storage container 133 and the nipple 135.

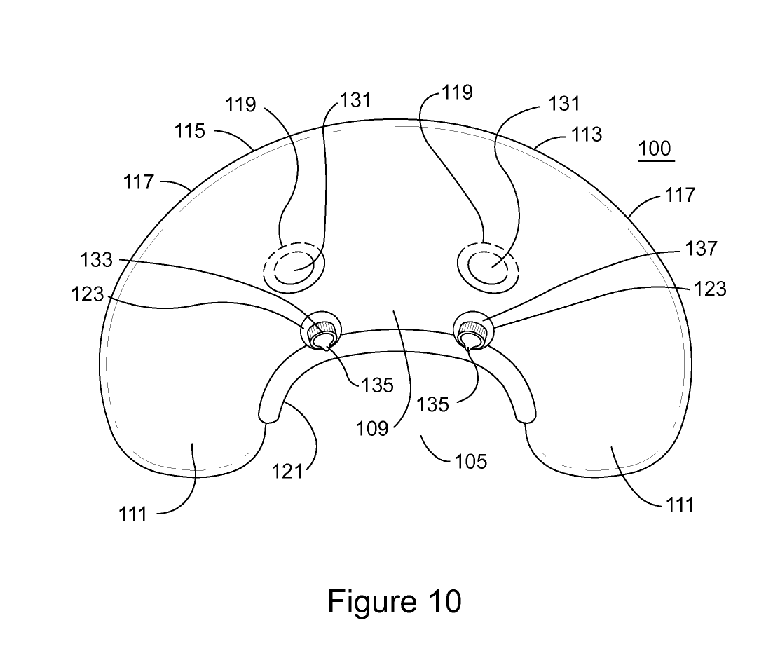

FIG. 10 illustrates another front view of the pet and animal feeder 100 and illustrates the feeding device 103, the concave section 105 the first concave surface 109, the second concave surface 111, the top surface 113, the back surface 115, the side surface 117, the first flexible seal 119, the second flexible seal 123, the outward extending protrusion 121 the feeding tube 131, the storage container 133 and the nipple 135.

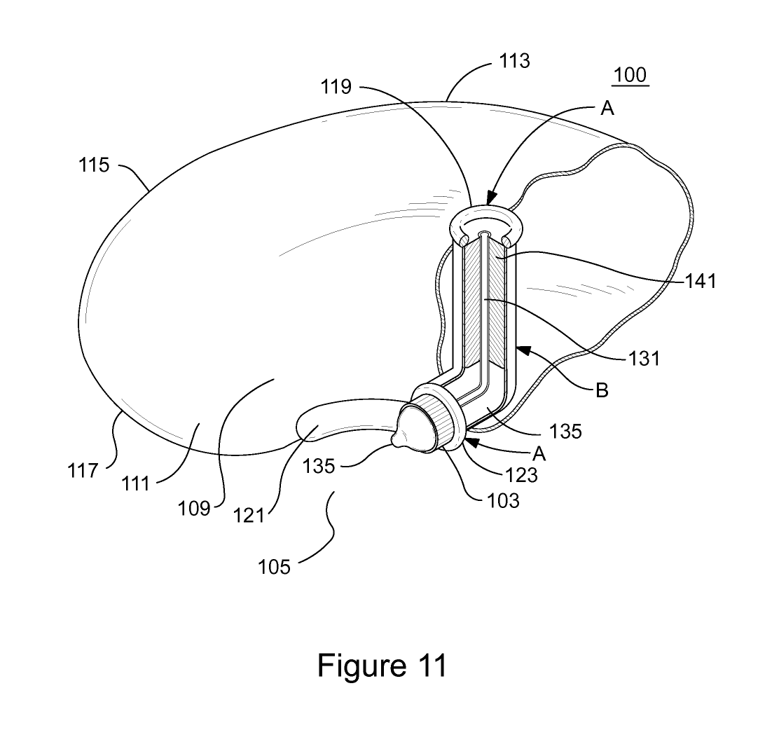

FIG. 11 illustrates a another front view of the pet and animal feeder 100 and illustrates the feeding device 103, the concave section 105 the first concave surface 109, the second concave surface 111, the top surface 113, the back surface 115, the side surface 117, the first flexible seal 119, the second flexible seal 123, the outward extending protrusion 121 the feeding tube 131, the storage container 133 and the nipple 135.

FIG. 11 additionally illustrates insulative material 141 which may surround a portion of the feeder device 103 in order to maintain the temperature of the liquid which may be placed within the feeder device 103 of the pet and animal feeder 100.

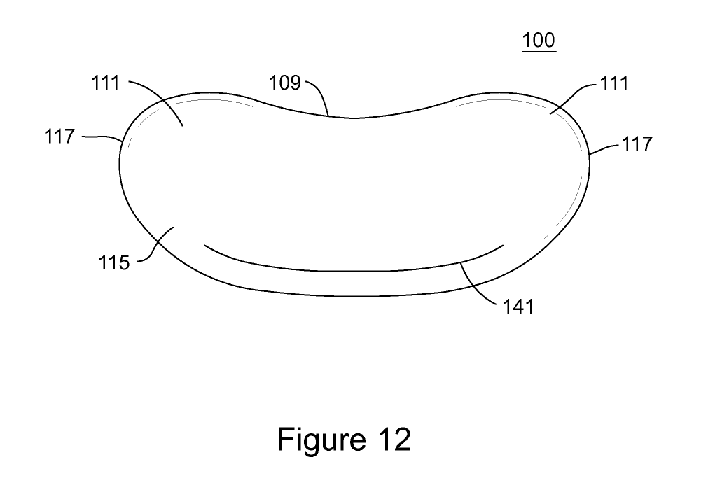

FIG. 12 illustrates a back view of the pet and animal feeder 100 and illustrates the first concave surface 109, the second convex surface 111, and the back surface 115 which may include a fastener device 141 to provide access to and to close an aperture of the back surface 115 and may include a zipper, buttons, Velcro such as hooks and loops or other fastening devices.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An animal feeder to feed an animal, comprising:
a hollow housing being substantially kidney shaped;
the hollow housing having a concave section being defined by a first concave surface and a pair of opposed convex surfaces;
a feeding device to feed the animals, wherein the animal feeds from the feeding device within the concave section.

2) An animal feeder to feed an animal as in claim 1, wherein the feeding device is substantially L-shaped.

3) An animal feeder to feed an animal as in claim 1, wherein the feeding device includes a feeding tube.

4) An animal feeder to feed an animal as in claim 1, wherein the feeding device includes a storage container.

5) An animal feeder to feed an animal as in claim 1, wherein the feeding device includes a nipple for the animal to feed from.

6) An animal feeder to feed an animal as in claim 1, wherein the pet and animal feeder includes insulation around the feeding device.

7) An animal feeder to feed an animal as in claim 1, wherein the back surface of the pet feeder includes a fastener device to provide access to the feeding device.

8) An animal feeder to feed an animal as in claim 7, wherein the fastener device includes a zipper.

9) An animal feeder to feed an animal as in claim 1, wherein the feeder device extends to the top surface of the pet feeder.
